(19) United States
(12) Patent Application Publication
(10) Pub. No.: US 2016/0034023 A1
(43) Pub. Date: Feb. 4, 2016

(54) DYNAMIC CACHE PREFETCHING BASED ON POWER GATING AND PREFETCHING POLICIES

(71) Applicant: Advanced Micro Devices, Inc., Sunnyvale, CA (US)

(72) Inventors: Manish ARORA, Dublin, CA (US); Indrani Paul, Round Rock, TX (US); Yasuko Eckert, Kirkland, WA (US); Joseph L. Greathouse, Austin, TX (US); Srilatha Manne, Portland, OR (US)

(21) Appl. No.: 14/448,096

(22) Filed: Jul. 31, 2014

(51) Int. Cl. G06F 1/32; G06F 12/08

(52) U.S. Cl. CPC G06F 1/3296; G06F 12/0862; G06F 1/3275; G06F 2212/69

(57) ABSTRACT

A system may determine that a processor has powered up. The system may determine a first prefetching policy based on determining that the processor has powered up. The system may fetch information, from a main memory and for storage by a cache associated with the processor, using the first prefetching policy. The system may determine, after fetching information using the first prefetching policy, to apply a second prefetching policy that is different than the first prefetching policy. The system may fetch information, from the main memory and for storage by the cache, using the second prefetching policy.

### BACKGROUND

Power gating is a technique used in integrated circuit design to reduce power consumption by shutting off or reducing an electric current to blocks of the circuit that are not in use. Power gating may be used to reduce energy consumption, to prolong battery life, to reduce cooling requirements, to reduce noise, to reduce operating costs for energy and cooling, etc. A processor may implement power gating techniques by dynamically activating or deactivating one or more components of the processor.

### SUMMARY OF EXAMPLE EMBODIMENTS

According to some possible implementations, a method may include determining, by a device, that a processor has transitioned from a first power consumption state to a second power consumption state. The method may include determining, by the device, a first prefetching policy based on determining that the processor has transitioned from the first power consumption state to the second power consumption state. The first prefetching policy may be a policy for prefetching information to be provided to a cache. The method may include determining, by the device, that a prefetch modification event has occurred. The method may include determining, by the device, a second prefetching policy based on determining that the prefetch modification event has occurred. The second prefetching policy may be different from the first prefetching policy.

According to some possible implementations, a device may detect that a processor has transitioned from a low power state to a high power state. The device may determine a first prefetching policy based on detecting that the processor has transitioned from the low power state to the high power state. The device may prefetch information, for storage by a cache associated with the processor, based on the first prefetching policy. The device may determine a second prefetching policy after prefetching information based on the first prefetching policy. The second prefetching policy may be different from the first prefetching policy. The device may prefetch information, for storage by the cache, based on the second prefetching policy.

According to some possible implementations, a system may determine that a processor has powered up. The system may determine a first prefetching policy based on determining that the processor has powered up. The system may fetch information, from a main memory and for storage by a cache associated with the processor, using the first prefetching policy. The system may determine, after fetching information using the first prefetching policy, to apply a second prefetching policy that is different than the first prefetching policy. The system may fetch information, from the main memory and for storage by the cache, using the second prefetching policy.

### BRIEF DESCRIPTION OF THE DRAWINGS

FIG. 1 is a diagram of an overview of an example embodiment described herein;

FIG. 2 is a diagram of an example device in which systems and/or methods described herein may be implemented, in some embodiments;

FIG. 3 is a flow chart of an example process for prefetching information for a processor cache using a throttle-up prefetching policy;

FIGS. 4A-4C are diagrams of an example embodiment relating to the example process shown in FIG. 3;

FIG. 5 is a flow chart of an example process for prefetching information for a processor cache using a throttle-down prefetching policy;

FIGS. 6A-6C are diagrams of an example embodiment relating to the example process shown in FIG. 5; and

FIGS. 7A-7C are diagrams of another example embodiment relating to the example process shown in FIG. 5.

### DETAILED DESCRIPTION OF EXAMPLE EMBODIMENTS

The following detailed description of example embodiments refers to the accompanying drawings. The same reference numbers in different drawings may identify the same or similar elements.

A computing device may perform power gating by dynamically activating or deactivating one or more processors. For example, the computing device may power down a processor when demand for processing power is low, and may power up a processor when demand for processing power is high. A drawback of power gating is that when a processor is powered down, information stored in the processor's cache may be reduced or removed. When the processor is powered up, initial processing may be slowed down while the processor fetches information from main memory and stores that information in the cache for processing. This slowdown may be particularly costly in scenarios with extensive power gating, where processors or processor cores may be powered up or powered down hundreds or thousands of times per second.

To speed up initial processing, the processor may perform a prefetching operation to bring data or instructions from main memory into the cache before the data or instructions are needed. Embodiments described herein may prefetch information using an aggressive prefetching policy that fills the cache quickly upon detecting that a processor has been powered up. Embodiments described herein may also adjust a manner in which prefetching is performed by using different prefetching policies based upon different conditions associated with the processor. In this way, a processor may operate more efficiently.

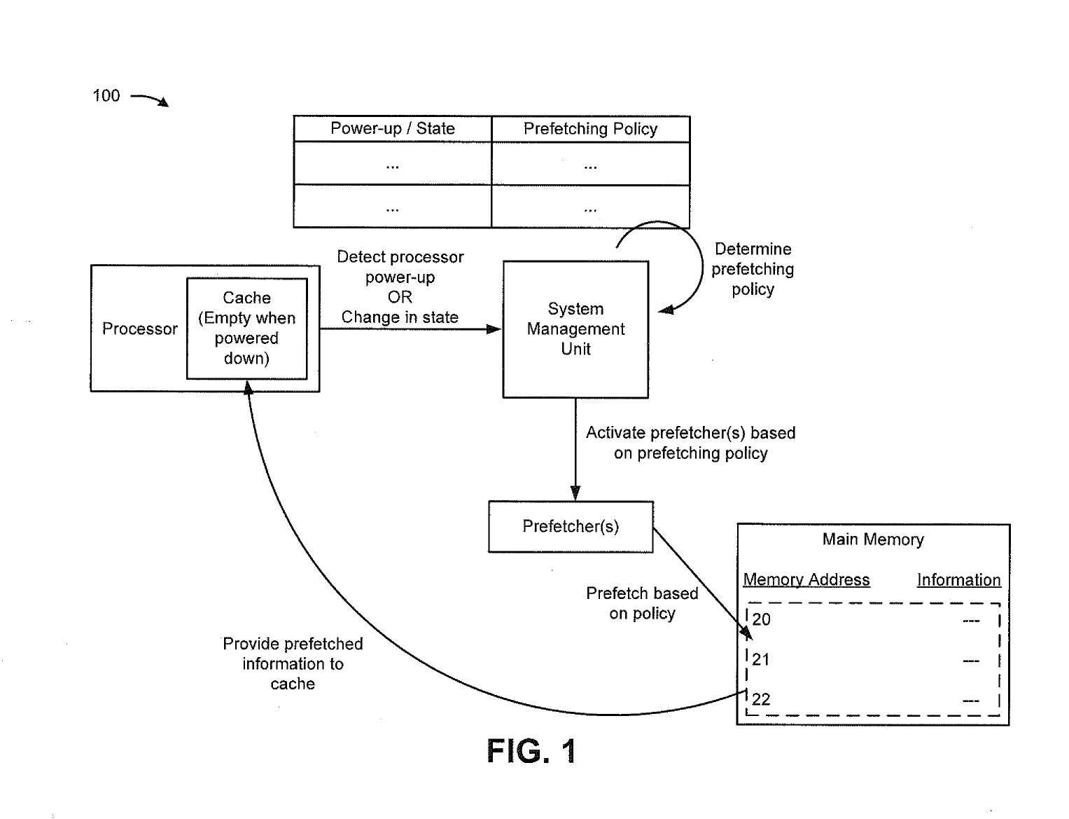

FIG. 1 is a diagram of an overview of an example embodiment 100 described herein. As shown in FIG. 1, a processor may include a cache that stores information for processing. The processor may process the cached information more quickly than information that is stored elsewhere, such as in main memory. However, the cache may be empty (e.g., may not store any information) when the processor is powered down. Thus, when the processor is powered up, initial processing may occur more slowly than if the cache was populated with information, because the processor will have to fetch information from main memory (or another memory location other than the cache) to fill the cache.

As further shown in FIG. 1, a system management unit may detect that the processor has powered up, or that the processor has undergone a change in state. The system management unit may determine a prefetching policy to be applied to the processor based on the state of the processor, and may activate one or more prefetchers based on the prefetching policy. For example, when the system management unit detects that the processor has powered up, the system management unit may select an aggressive prefetching policy that quickly fills the cache with information from main memory. As another example, when the system management unit detects that the processor has been powered up for a particular amount of time (and/or that the cache has been filled to a particular amount), then the system management unit may select a less aggressive prefetching policy.

As further shown, the prefetcher(s) may prefetch information (e.g., data, an instruction, etc.) from main memory, and may provide the prefetched information to the cache for storage. The prefetched information may include information predicted to be needed by the processor. In this way, the system management unit may enhance processor performance by quickly populating the cache when the processor powers up, thereby reducing overhead (e.g., wasted time and/or computing resources) associated with power gating. Furthermore, the system management unit may apply different prefetching policies based on current conditions associated with the processor, thereby enhancing processing efficiencies.

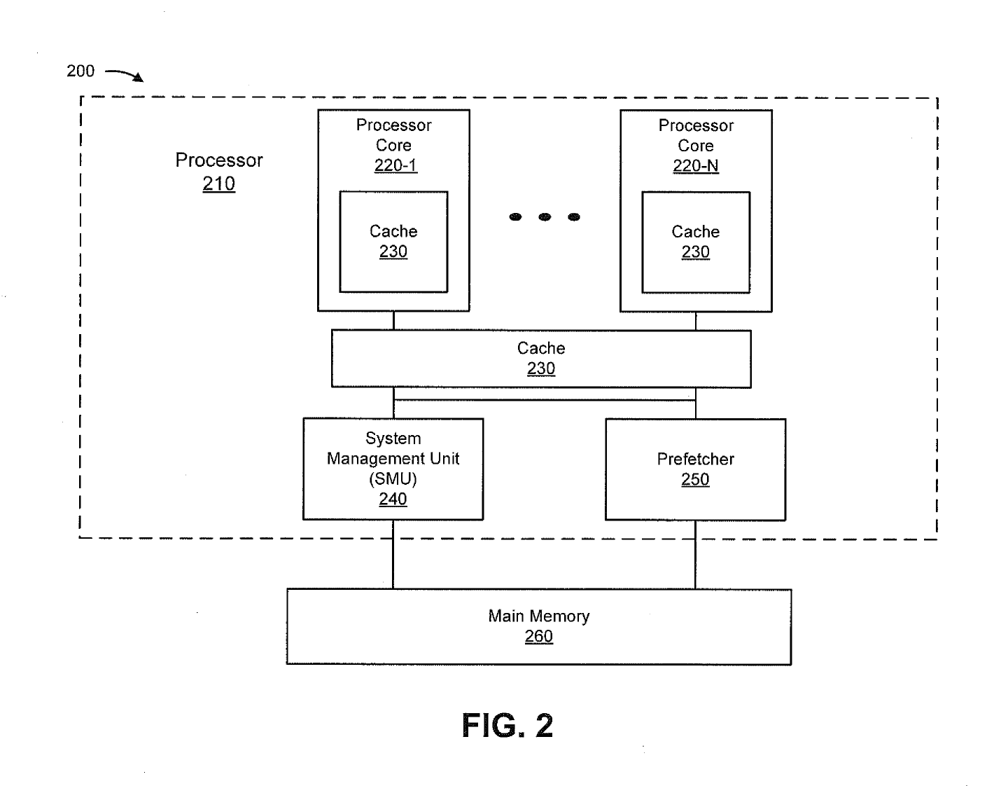

FIG. 2 is a diagram of an example device 200 in which systems and/or methods described herein may be implemented, in some embodiments. As shown, device 200 may include a processor 210. Processor 210 may include one or more processor cores 220-1 through 220-N (N>1) (hereinafter referred to collectively as “processor cores 220,” and individually as “processor core 220”), which may include one or more caches 230. Furthermore, device 200 may include a system management unit (SMU) 240, a prefetcher 250, and a main memory 260. Components of device 200 may connect via wired connections, buses, etc.

Processor 210 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. In some embodiments, processor 210 includes one or more processor cores 220 that read and/or execute instructions. Processor 210 and/or processor core 220 may be associated with one or more caches 230.

Cache 230 may include a storage component in which information (e.g., an instruction, data, etc.) may be stored. In some embodiments, cache 230 includes a CPU cache, located in or near processor core 220, that permits processor core 220 to access information stored in cache 230 faster than if the information were not stored in cache 230 and would need to be fetched from main memory 260. For example, cache 230 may include a data cache, an instruction cache, a cache associated with a particular cache level (e.g., a Level 1 cache, a Level 2 cache, a Level 3 cache, etc.), or the like. When processor 220 is powered down, information stored in cache 230 may be flushed (e.g., removed) from cache 230, and/or an amount of information stored by cache 230 may be reduced (e.g., from an amount of information stored in cache 230 when processor core 220 is powered up). As shown, cache 230 may include a private cache associated with a particular processor core 220, or may include a shared cache shared by two or more processors cores 220. The quantity of cache levels shown is provided as an example. In some embodiments, processor 210 includes a different quantity of cache levels.

SMU 240 may include one or more components, such as a power controller, that control power to other components of device 200, such as processor core 220 and/or cache 230. For example, SMU 240 may power down one or more processor cores 220 when demand for processing power is low, and may power up one or more processor cores 220 when demand for processing power is high. Additionally, or alternatively, SMU 240 may power up or power down one or more processor cores 220 based on available battery life of device 220. Additionally, or alternatively, SMU 240 may power up or power down one or more processor cores 220 based on receiving an instruction to power up or power down.

Additionally, or alternatively, SMU 240 may include one or more components, such as a memory controller, that manage a flow of information going to and from main memory 260. For example, SMU 240 may include a component to read from and write to main memory 260. In some embodiments, SMU 240 determines a prefetching policy based on determining that processor core 220 has powered up and/or changed state, and may notify one or more prefetchers 250 of the prefetching policy.

Prefetcher 250 may include one or more components that prefetch information (e.g., data or instructions) from main memory 260, and provide the information to cache 230 for storage and/or later use by processor core 220. Prefetcher 250 may employ one or more prefetching algorithms to determine information to be prefetched (e.g., from a particular memory address of main memory 260) and/or an amount of information to be prefetched.

Main memory 260 may include one or more components that store information. For example, main memory 260 may include random access memory (RAM), a read-only memory (ROM), etc. Main memory 260 may store information identified by a memory address. Main memory 260 may be located farther away from processor core 220 than cache 230. As such, requests from processor core 220 to main memory 260 may take a longer amount of time to process than requests from processor core 220 to cache 230.

Device 200 may perform one or more processes described herein. Device 200 may perform these processes in response to processor 210 (e.g., one or more processor cores 220) executing instructions (e.g., software instructions) stored by a computer-readable medium, such as main memory 260. A computer-readable medium is defined herein as a non-transitory memory device. A memory device includes memory space within a single physical storage device or memory space spread across multiple physical storage devices. For example, a computer-readable medium may include cache 230 and/or main memory 260.

Instructions may be read into main memory 260 and/or cache 230 from another computer-readable medium, from another component, and/or from another device via a communication bus. When executed, instructions stored in main memory 260 and/or cache 230 may cause device 200 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number of components shown in FIG. 2 is provided as an example. In practice, device 200 may include additional components, fewer components, different components, or differently arranged components than those shown in FIG. 2. Additionally, one or more of the components of device 200 may perform one or more functions described as being performed by another one or more components of device 200.

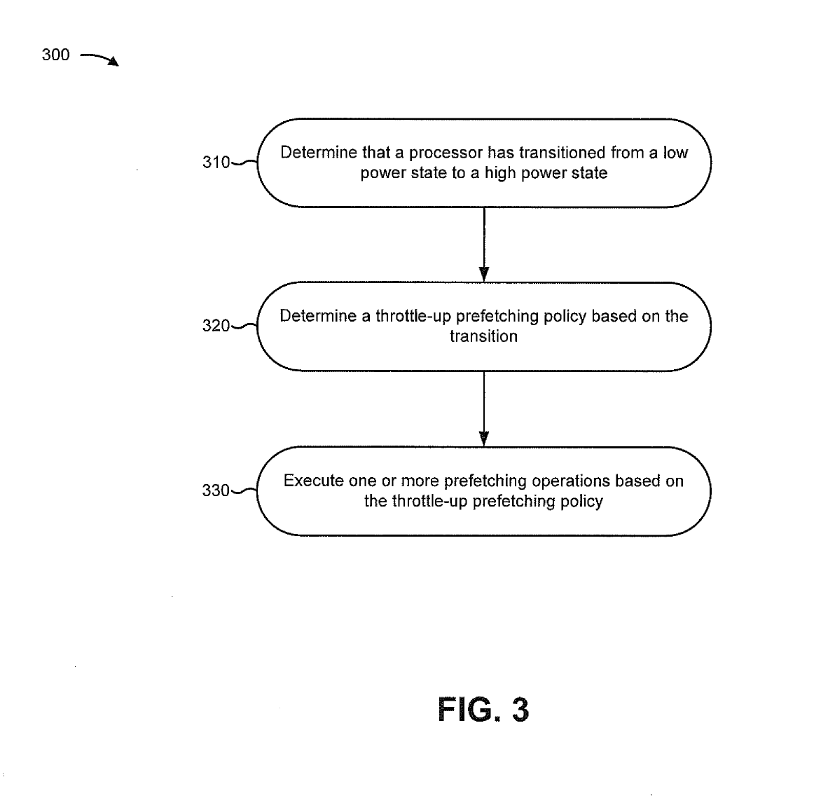

FIG. 3 is a flow chart of an example process 300 for prefetching information for a processor cache using a throttle-up prefetching policy. In some embodiments, one or more process blocks of FIG. 3 are performed by SMU 240. In some embodiments, one or more process blocks of FIG. 3 are performed by another component or a group of components separate from or including SMU 240, such as processor 210, processor core 220, cache 230, prefetcher 250, and/or main memory 260.

As shown in FIG. 3, process 300 may include determining that a processor has transitioned from a low power state to a high power state (block 310). For example, SMU 240 may determine that processor core 220 has transitioned from a low power state (e.g., powered off, operating at a lower frequency, consuming a lower amount of power, etc.) to a high power state (e.g., powered on, operating at a higher frequency, consuming a higher amount of power, etc.). In some embodiments, SMU 240 determines that processor core 220 has transitioned from a low power state to a high power state based on powering up processor core 220, based on information received from processor core 220 (e.g., an indication that processor core 220 has been powered up), and/or information received from another device and/or component. Additionally, or alternatively, SMU 240 may monitor a power state of processor core 220 (e.g., an amount of power consumed by processor core 220) to detect that processor core 220 has transitioned from the low power state to the high power state.

In some embodiments, SMU 240 powers up processor core 220 by adjusting a power characteristic of processor core 220 so that processor core 220 may be utilized to read and/or execute instructions. For example, SMU 240 may power up processor core 220 by supplying power (e.g., a current, a voltage, etc.) to processor core 220 and/or turning on processor core 220. As another example, SMU 240 may power up processor core 220 by transitioning processor core 220 from a first power consumption state (e.g., off, asleep, on standby, hibernating, etc.) to a second power consumption state (e.g., on, awake, ready, etc.), where the amount of power consumed by processor core 220 in the first power consumption state is less than the amount of power consumed by processor core 220 in the second power consumption state.

As an example, processor core 220 may be in a particular C-state. Example C-states include C0 (e.g., an operating mode where processor core 220 is fully powered up), C1 (e.g., a halt mode where main internal clocks of processor core 220 are stopped, but bus interfaces and an advanced programmable interrupt controller are active), C2 (e.g., a stop clock mode where internal and external clocks are stopped), C3 (e.g., a sleep mode that stops internal clocks and reduces CPU voltage), C4 (e.g., a deeper sleep mode that reduces CPU voltage more than the C3 state), C5 (e.g., an enhanced deeper sleep mode that reduces CPU voltage more than the C4 state, and that turns off cache 230), C6 (e.g., a power down mode that reduces CPU internal voltage to a particular value, such as zero volts), etc. Each C-state may be associated with a different level of power consumption. These C-states are provided merely as an example. In some embodiments, SMU 240 determines that processor core 220 has transitioned from a C6 state to a C0 state (e.g., from a power down mode to an operating mode).

Additionally, or alternatively, SMU 240 may determine that cache 230 has powered up and/or transitioned from a low power state to a high power state. For example, SMU 240 may determine that cache 230 has transitioned out of a low power state that causes an amount of information stored by cache 230 to be reduced (e.g., that causes information to be flushed from cache 230) from an amount of information stored by cache 230 during a high power state.

As further shown in FIG. 3, process 300 may include determining a throttle-up prefetching policy based on the transition (block 320). For example, SMU 240 may determine a throttle-up prefetching policy based on determining that processor core 220 has transitioned from a low power state to a high power state. A throttle-up prefetching policy may include a prefetching policy that prefetches information from main memory 260 more aggressively (e.g., that fills cache 230 more quickly) than another prefetching policy (e.g., a throttle-down prefetching policy). The information stored by cache 230 may have been reduced and/or flushed as a result of entering the low power state. SMU 240 may apply the throttle-up prefetching policy to quickly fill cache 230 with information upon power up.

In some embodiments, SMU 240 determines the throttle-up prefetching policy by analyzing a set of factors associated with processor core 220 (and/or cache 230 associated with processor core 220). For example, SMU 240 may determine the throttle-up prefetching policy based on a previous state of processor core 220 (e.g., a power state from which processor core 220 transitioned), based on a current state of processor core 220 (e.g., a power state into which processor core 220 transitioned), based on an amount of time that processor core 220 is in a particular state (e.g., an amount of time that processor core 220 was powered down, an amount of time that processor core 220 has been powered up, etc.), based on an architecture of processor core 220, based on a type of processor core 220 (e.g., whether processor core 220 is associated with a CPU, a GPU, an APU, etc.), based on a capability and/or a parameter of processor core 220 (e.g., a frequency at which processor core 220 operates, a quantity of caches 230 associated with a particular processor core 220, etc.), based on a performance parameter associated with processor core 220 and/or cache 230, and/or based on any combination of the above factors and/or other factors.

SMU 240 may compare one or more factors to a set of conditions to determine the throttle-up prefetching policy. For example, SMU 240 may determine a first throttle-up prefetching policy if a first set of conditions is satisfied, may determine a second throttle-up prefetching policy if a second set of conditions is satisfied, etc.

Additionally, or alternatively, SMU 240 may calculate a score based on one or more factors. SMU 240 may assign a weight to one or more factors using a same weight value or different weight values. SMU 240 may determine a throttle-up prefetching policy based on the score (e.g., by comparing the score to a threshold). In some embodiments, SMU 240 performs a lookup operation to determine the throttle-up prefetching policy (e.g., based on a set of factors, a set of conditions, a score, etc.). As an example, SMU 240 may calculate a score based on a frequency at which processor core 220 operates and a memory size of a cache associated with processor core 220.

The throttle-up prefetching policy may specify a manner in which one or more prefetchers 250 prefetch information for storage by cache 230. For example, the throttle-up prefetching policy may specify a type of prefetcher 250 to be activated (e.g., may identify one or more prefetchers 250 to be activated, such as an untrainable prefetcher that cannot be trained to make better predictions over time, a trainable prefetcher that may be trained to make better predictions over time, etc.), may specify a quantity of prefetchers 250 to be activated, may specify one or more prefetching algorithms to be executed, may specify a quantity of prefetching requests (e.g., outstanding requests, active requests, etc.) permitted by a particular prefetcher 250, may specify a priority level associated with prefetch requests (e.g., whether prefetch requests are to be handled before or after cache miss requests), may specify a quantity of information to be requested (e.g., a quantity of memory addresses from which information is to be prefetched), etc.

In some embodiments, the throttle-up prefetching policy causes information to be prefetched from main memory 260 more aggressively than a throttle-down prefetching policy. For example, the throttle-up prefetching policy may specify a first prefetcher 250 (and/or a first prefetching algorithm) that fills cache 230 more quickly than a second prefetcher 250 (and/or a second prefetching algorithm) specified by the throttle-down prefetching policy, may activate a greater quantity of prefetchers 250 than the throttle-down prefetching policy, may permit a greater quantity of prefetch requests than the throttle-down prefetching policy, may apply a higher priority to prefetching requests than the throttle-down prefetching policy, may permit a greater quantity of information to be requested than the throttle-down prefetching policy, etc.

As further shown in FIG. 3, process 300 may include executing one or more prefetching operations based on the throttle-up prefetching policy (block 330). For example, SMU 240 may provide information, identified by the throttle-up prefetching policy, to one or more prefetchers 250. Prefetcher 250 may execute a prefetching operation based on the received information. For example, prefetcher 250 may prefetch information from main memory 260, and may provide the prefetched information to cache 230 for storage. Prefetcher 250 may prefetch the information in a manner specified by the throttle-up prefetching policy.

Additionally, or alternatively, prefetcher 250 may execute a prefetching operation based on information stored as a result of powering down processor core 220. For example, SMU 240 may cause training information, used to train prefetcher 250 to make better prefetching decisions, to be stored when processor core 220 is powered down. SMU 240 may instruct prefetcher 250 to use this training information upon being activated (e.g., after processor core 220 is powered up). The training information may include, for example, information that identifies a set of last prefetched information (e.g., before processor core 220 was powered down), a set of memory addresses from which information was last prefetched, a set of last states of prefetcher 250, a set of memory addresses associated with a set of last cache miss requests, etc.

As an example, prefetcher 250 may predict information likely to be used by processor core 220 (e.g., to reduce future cache misses). An untrainable prefetcher 250 may make a prediction using the same function every time a prediction is made (e.g., fetch information from the next sequential memory address). As such, an untrainable prefetcher 250 may not make better predictions over time. On the other hand, a trainable prefetcher 250 may make a prediction by modifying the function over time to make a better prediction. The trainable prefetcher 250 may use training information to modify the function to make a better prediction.

In this way, SMU 240 and prefetcher 250 may assist in quickly filling cache 230 with information when processor core 220 is powered up. This may increase an operating efficiency of processor core 220 by reducing a quantity of cache misses that require information to be fetched (e.g., by a cache miss fetcher) from main memory 260.

Although FIG. 3 shows example blocks of process 300, in some embodiments, process 300 includes additional blocks, fewer blocks, different blocks, or differently arranged blocks than those depicted in FIG. 3. Additionally, or alternatively, two or more of the blocks of process 300 may be performed in parallel.

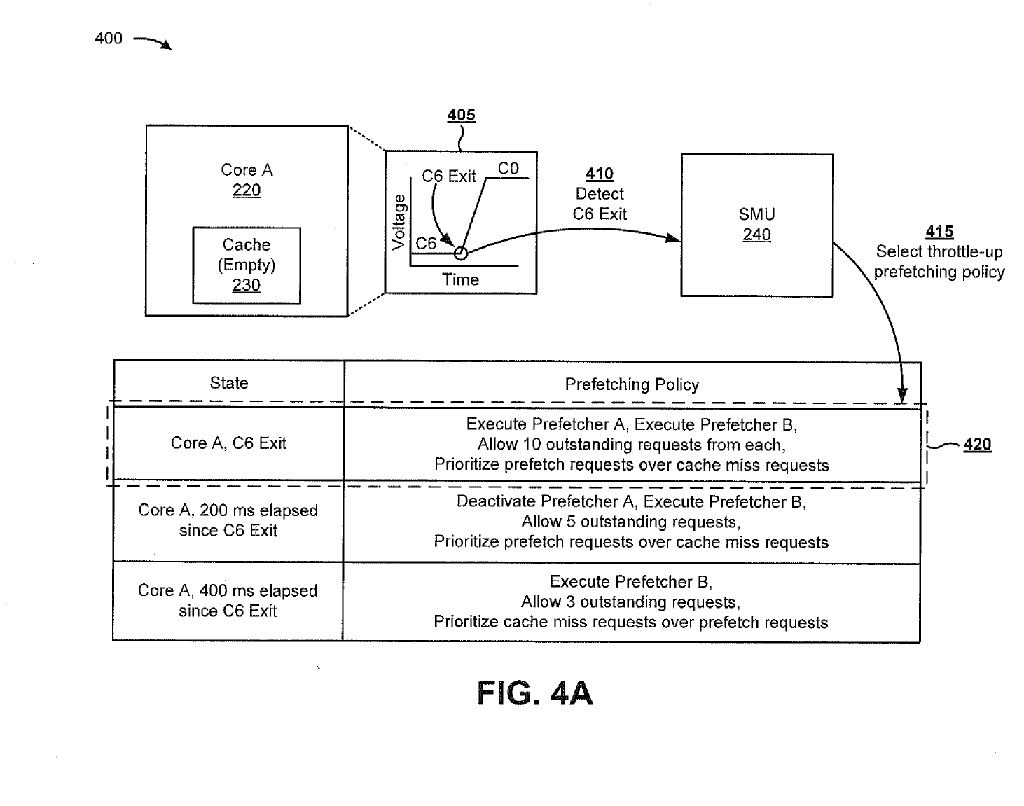

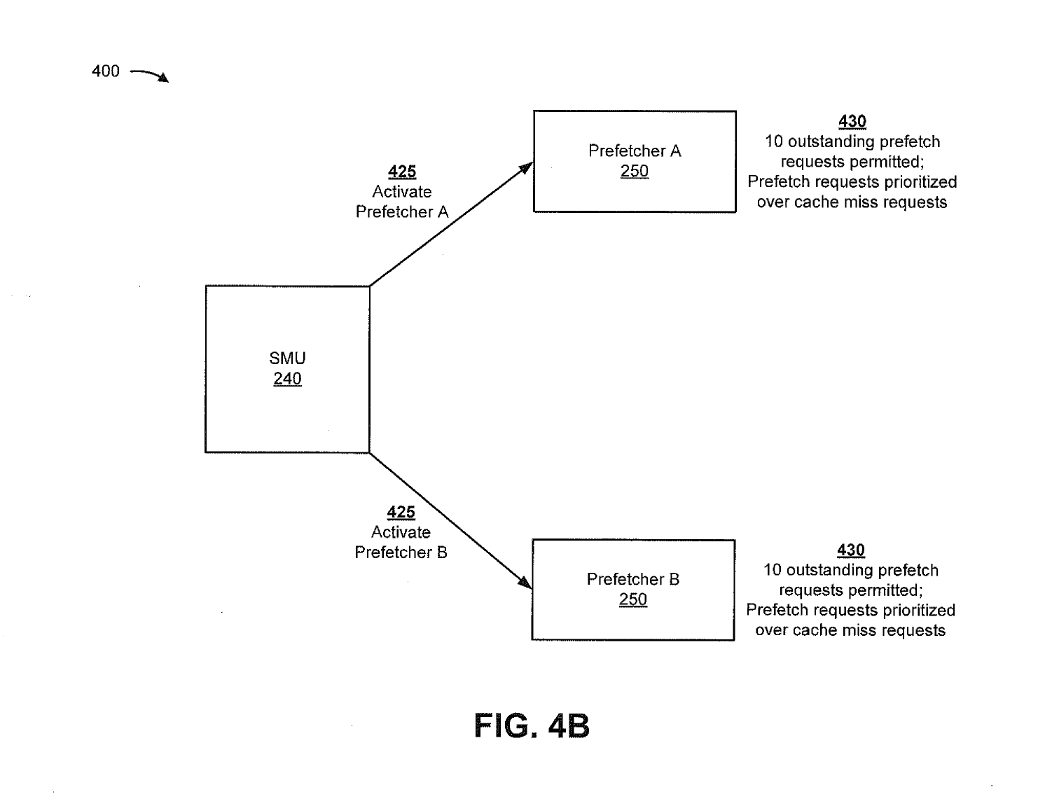

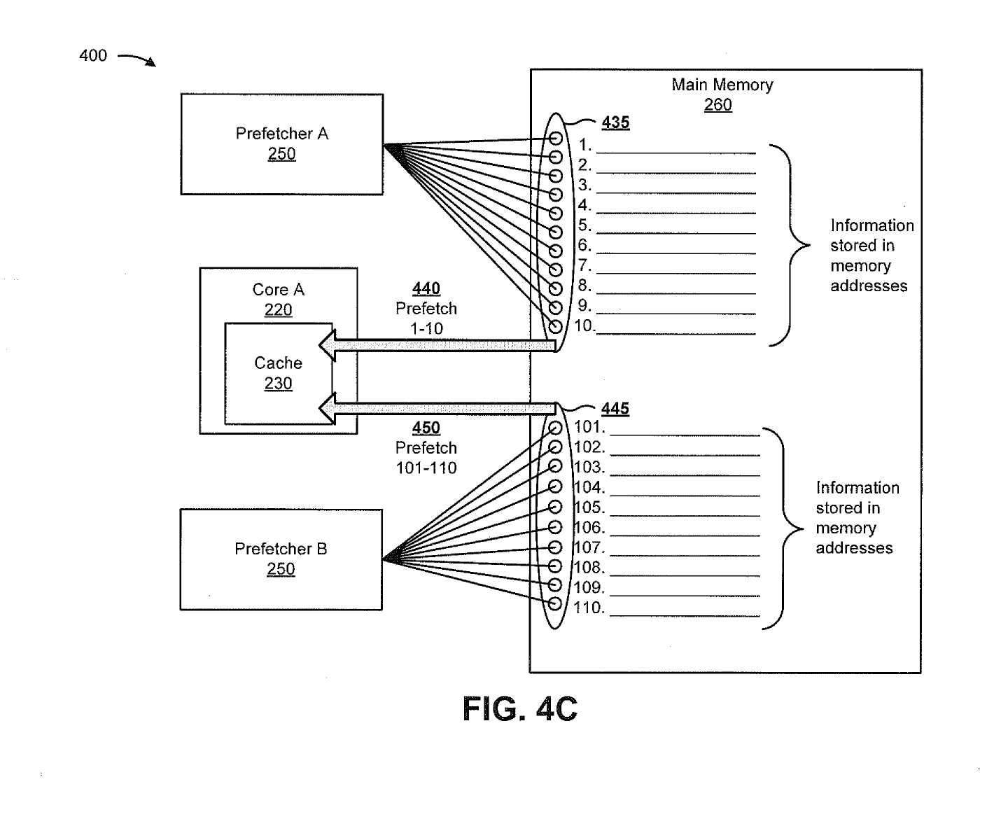

FIGS. 4A-4C are diagrams of an example embodiment 400 relating to example process 300 shown in FIG. 3. FIGS. 4A-4C show an example of prefetching data for a processor cache using a throttle-up prefetching policy.

For the purpose of FIG. 4A, assume that a particular processor core 220, shown as Core A, is powered down in a C6 state (e.g., a powered down mode). Further, assume that cache 230, associated with Core A, is empty. At a later time, assume that Core A is powered on, and exits the C6 state to enter a C0 state (e.g., an operating mode), as shown by reference number 405. As shown by reference number 410, assume that SMU 240 detects that Core A exited the C6 state. As shown by reference number 415, assume that SMU 240 consults a state table to select a throttle-up prefetching policy based on a current state of Core A.

As shown by reference number 420, assume that the current state of Core A is “C6 Exit,” indicating that Core A has exited the C6 state. As further shown, based on this current state, SMU 240 selects a prefetching policy that causes execution of two prefetchers, shown as Prefetcher A and Prefetcher B. Furthermore, the selected prefetching policy permits ten outstanding prefetch requests from each of Prefetcher A and Prefetcher B, and prioritizes prefetch requests over cache miss requests. Assume that Prefetcher A is an untrainable prefetcher (e.g., that utilizes a next-line algorithm), and that Prefetcher B is a trainable prefetcher (e.g., that may be trained to make better prefetching decisions over time).

As shown in FIG. 4B, and by reference number 425, based on the selected prefetching policy, SMU 240 activates Prefetcher A and Prefetcher B. As shown by reference number 430, SMU 240 instructs Prefetchers A and B that ten outstanding prefetch requests are permitted (e.g., from each Prefetcher), and that prefetch requests are to be prioritized over cache miss requests.

As shown in FIG. 4C, and by reference number 435, Prefetcher A requests, from main memory 260, information from ten memory addresses shown as 1 through 10, in accordance with the selected prefetching policy. As shown by reference number 440, main memory 260 provides the information stored in memory addresses 1 through 10 to cache 230. As shown by reference number 445, Prefetcher B requests, from main memory 260, information from ten memory addresses shown as 100 through 110, in accordance with the selected prefetching policy. As shown by reference number 450, main memory 260 provides the information stored in the memory addresses 100 through 110 to cache 230. In this way, Prefetchers A and B may quickly fill cache 230 with information upon power up.

As indicated above, FIGS. 4A-4C are provided merely as an example. Other examples are possible and may differ from what was described with regard to FIGS. 4A-4C.

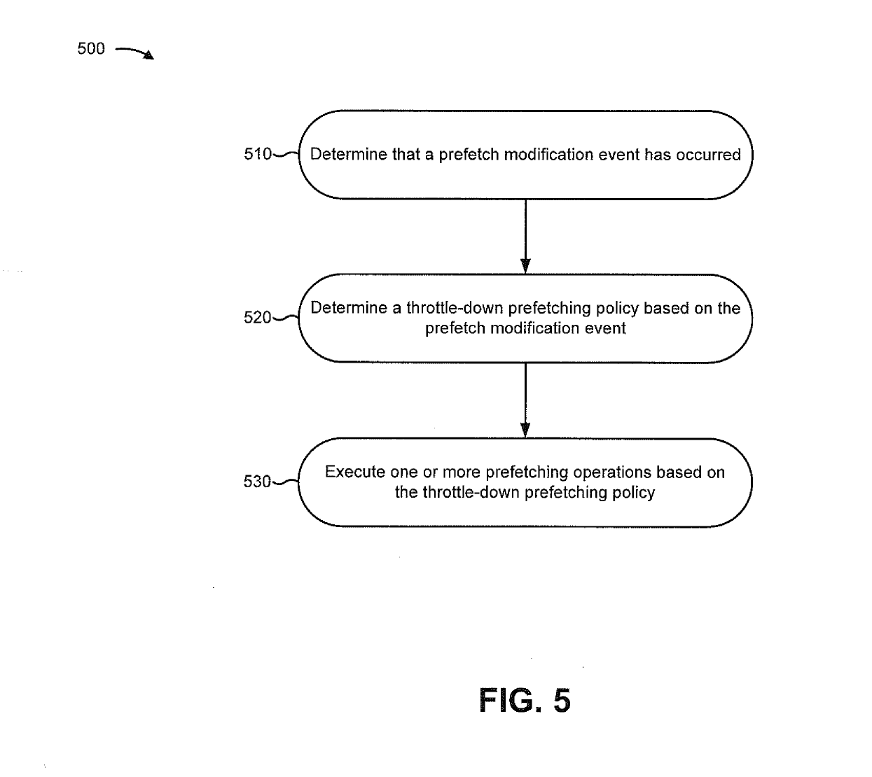

FIG. 5 is a flow chart of an example process 500 for prefetching information for a processor cache using a throttle-down prefetching policy. In some embodiments, one or more process blocks of FIG. 5 are performed by SMU 240. In some embodiments, one or more process blocks of FIG. 5 are performed by another component or a group of components separate from or including SMU 240, such as processor 210, processor core 220, cache 230, prefetcher 250, and/or main memory 260.

As shown in FIG. 5, process 500 may include determining that a prefetch modification event has occurred (block 510). For example, SMU 240 may determine that a prefetch modification event has occurred by detecting the prefetch modification event. Additionally, or alternatively, SMU 240 may determine that the prefetch modification event has occurred based on information received from another device and/or component (e.g., processor 210, processor core 220, cache 230, etc.).

In some embodiments, SMU 240 determines that the prefetch modification event has occurred by determining that a threshold amount of time has passed since a particular event. For example, SMU 240 may determine that a prefetch modification event has occurred when a threshold amount of time has passed since processor core 220 transitioned from a first power consumption state (e.g., a low power state, such as a C6 state) to a second power consumption state (e.g., a high power state, such as a C0 state).

Additionally, or alternatively, SMU 240 may determine that the prefetch modification event has occurred based on a performance parameter associated with processor core 220 and/or cache 230. For example, SMU 240 may determine that a prefetch modification event has occurred when a cache miss rate (e.g., a quantity of cache misses in a particular time frame) satisfies a threshold, when a cache hit rate (e.g., a quantity of cache hits in a particular time frame) satisfies a threshold, when a threshold quantity of information stored in cache 230 is invalid, when a threshold quantity of information has been prefetched, when cache 230 has been filled by a threshold amount (e.g., a threshold amount of memory, a threshold percentage of total memory on cache 230, etc.), when a load on processor core 220 satisfies a threshold, etc.

As further shown in FIG. 5, process 500 may include determining a throttle-down prefetching policy based on the prefetch modification event (block 520). For example, SMU 240 may determine a throttle-down prefetching policy based on detecting the prefetch modification event. A throttle-down prefetching policy may include a prefetching policy that prefetches information from main memory 260 less aggressively (e.g., that fills cache 230 more slowly) than another prefetching policy (e.g., a throttle-up prefetching policy). SMU 240 may identify a throttle-down prefetching policy once cache 230 has been initially filled (e.g., by a threshold amount) using a throttle-up prefetching policy.

In some embodiments, SMU 240 determines the throttle-down prefetching policy by analyzing a set of factors associated with processor core 220 (and/or cache 230 associated with processor core 220). For example, SMU 240 may determine the throttle-down prefetching policy based on one or more factors described herein in connection with the throttle-up prefetching policy (e.g., block 320 of FIG. 3).

SMU 240 may compare one or more factors to a set of conditions to determine the throttle-down prefetching policy. For example, SMU 240 may determine a first throttle-down prefetching policy if a first set of conditions is satisfied, may determine a second throttle-down prefetching policy if a second set of conditions is satisfied, etc.

Additionally, or alternatively, SMU 240 may calculate a score based on one or more factors. SMU 240 may assign a weight to one or more factors using a same weight value or different weight values. SMU 240 may determine a throttle-down prefetching policy based on the score (e.g., by comparing the score to a threshold). In some embodiments, SMU 240 performs a lookup operation to determine the throttle-down prefetching policy (e.g., based on a set of factors, a set of conditions, a score, etc.). As an example, SMU 240 may calculate a score based on a processor load of processor core 220, a cache miss rate associated with cache 230, and an amount of information stored by cache 230.

The throttle-down prefetching policy may specify a manner in which one or more prefetchers 250 prefetch information for storage by cache 230. For example, the throttle-down prefetching policy may specify a type of prefetcher 250 to be activated, may specify a type of prefetcher 250 to be deactivated, may specify a quantity of prefetchers 250 to be activated, may specify one or more prefetching algorithms to be executed, may specify a quantity of prefetching requests permitted by a particular prefetcher 250, may specify a priority level associated with prefetching requests, may specify a quantity of information to be requested, etc.

In some embodiments, the throttle-down prefetching policy causes information to be prefetched from main memory 260 less aggressively than a throttle-up prefetching policy. For example, the throttle-down prefetching policy may specify a first prefetcher 250 (and/or a first prefetching algorithm) that fills cache 230 less quickly than a second prefetcher 250 (and/or a second prefetching algorithm) specified by the throttle-up prefetching policy, may activate a lesser quantity of prefetchers 250 than the throttle-up prefetching policy, may permit a lesser quantity of prefetch requests than the throttle-up prefetching policy, may apply a lower priority to prefetching requests than the throttle-up prefetching policy, may permit a lesser quantity of information to be requested than the throttle-up prefetching policy, etc.

As further shown in FIG. 5, process 500 may include executing one or more prefetching operations based on the throttle-down prefetching policy (block 530). For example, SMU 240 may provide information, identified by the throttle-down prefetching policy, to one or more prefetchers 250. Prefetcher 250 may execute a prefetching operation based on the received information. For example, prefetcher 250 may prefetch information from main memory 260, and may provide the prefetched information to cache 230 for storage. Prefetcher 250 may prefetch the information in a manner specified by the throttle-down prefetching policy. In some embodiments, the throttle-down prefetching policy causes a modification to a prefetcher 250 that is currently executing (e.g., that is currently executing based on a throttle-up prefetching policy). Additionally, or alternatively, the throttle-down prefetching policy causes a currently-executing prefetcher 250 (e.g., a prefetching algorithm) to stop executing, and/or causes a prefetcher 250 to be activated for execution.

As an example, SMU 240 may use a throttle-up prefetching policy to activate an untrainable prefetcher 250 that cannot be trained to make better prefetching decisions over time, and to also activate a trainable prefetcher 250 that can be trained to make better prefetching decisions over time. When SMU 240 detects a prefetch modification event, SMU 240 may deactivate the untrainable prefetcher 250, and may continue to permit the trainable prefetcher 250 to execute. In this way, SMU 240 may assist in filling cache 230 quickly using the untrainable prefetcher 250 (e.g., which may be faster than the trainable prefetcher 250) while the trainable prefetcher 250 is being trained. Once the trainable prefetcher 250 has been trained (e.g., after a threshold amount of time), SMU 240 may deactivate the untrainable prefetcher 250 while allowing the trainable prefetcher 250 to continue to execute.

In this way, SMU 240 and prefetcher 250 may assist in slowing down the amount of information prefetched for cache 230 after cache 230 has been initially filled following power up of processor core 220. This may increase an operating efficiency of processor core 220 by dedicating resources to more important cache requests (e.g., cache miss requests) after cache 230 has been initially filled.

Although FIG. 5 shows example blocks of process 500, in some embodiments, process 500 includes additional blocks, fewer blocks, different blocks, or differently arranged blocks than those depicted in FIG. 5. Additionally, or alternatively, two or more of the blocks of process 500 may be performed in parallel.

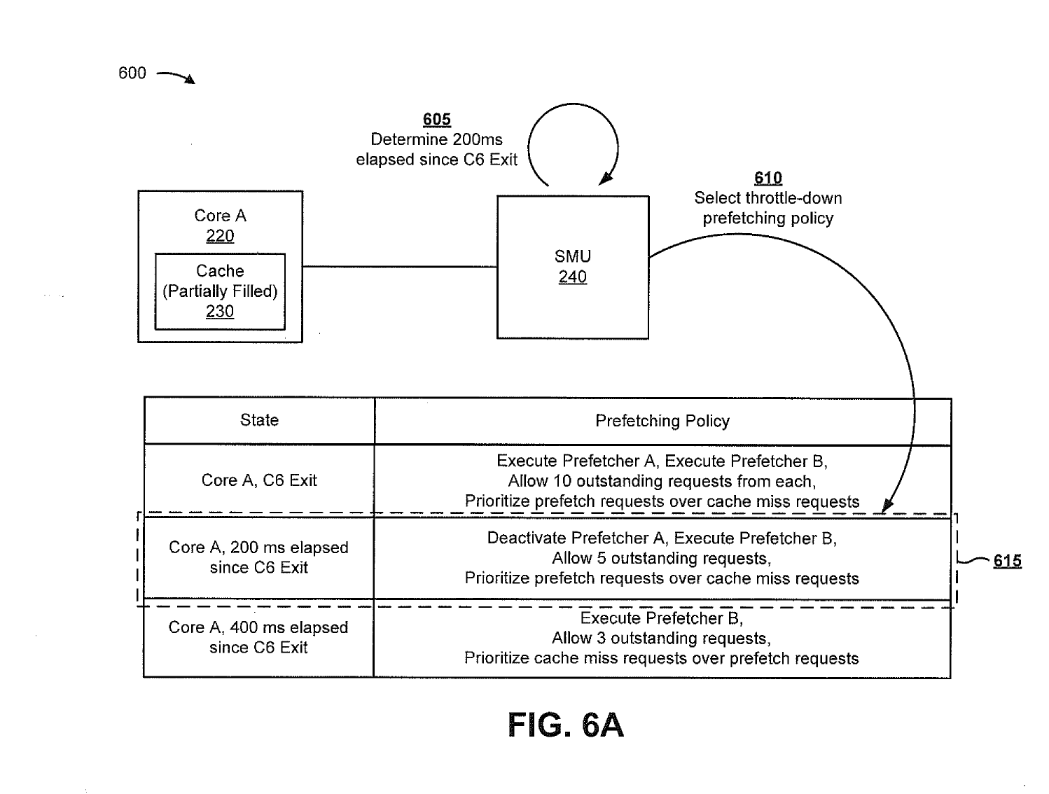

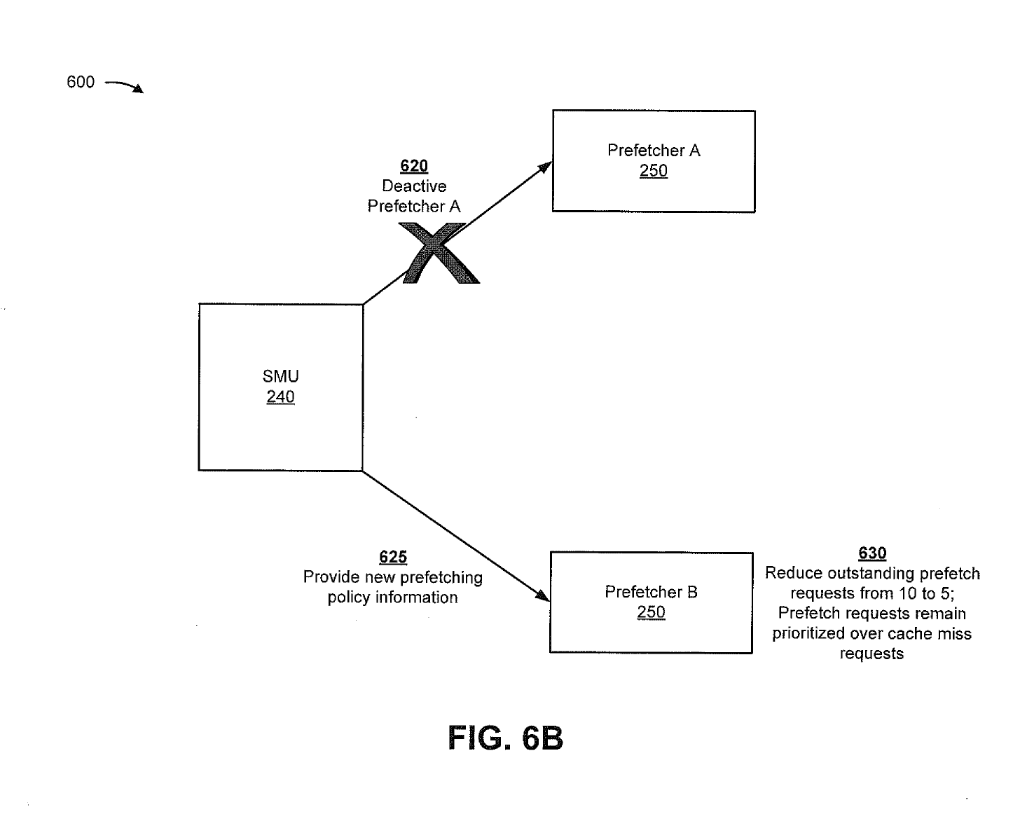

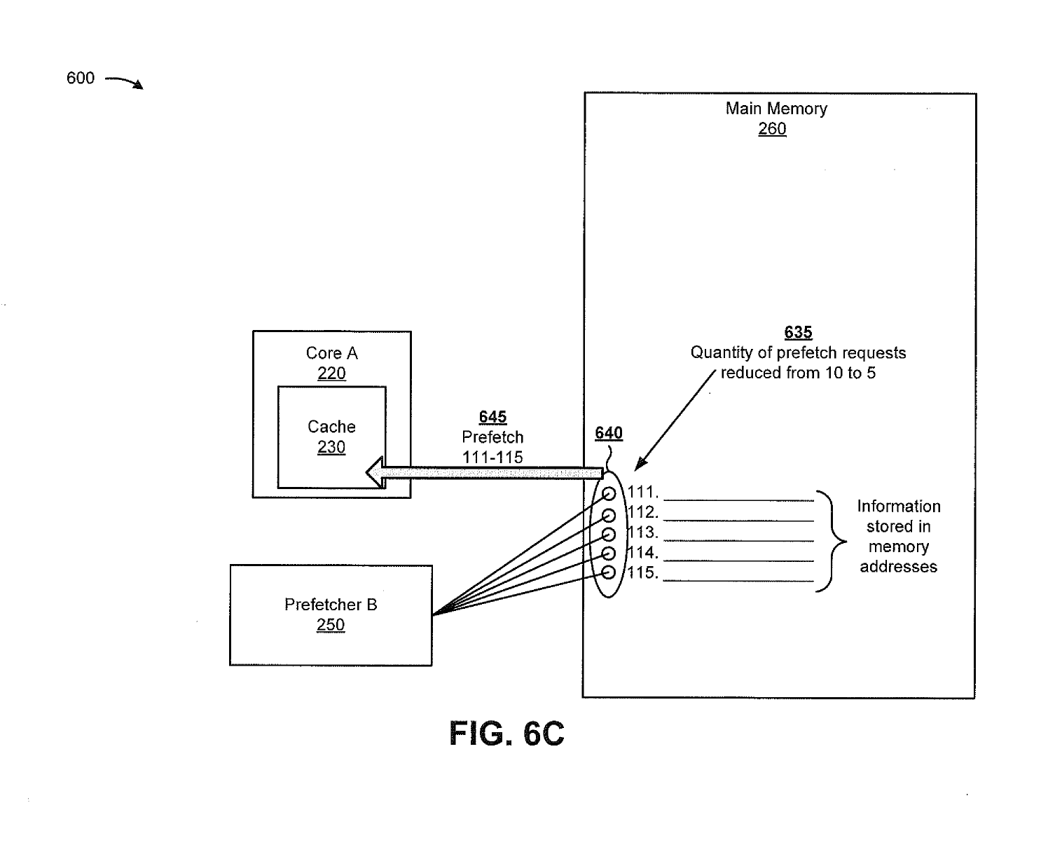

FIGS. 6A-6C are diagrams of an example embodiment 600 relating to example process 500 shown in FIG. 5. FIGS. 6A-6C show an example of prefetching data for a processor cache using a throttle-down prefetching policy. For the purpose of FIGS. 6A-6C, assume that the operations described in connection with example embodiment 400 of FIGS. 4A-4C have been performed.

As shown in FIG. 6A, and by reference number 605, assume that SMU 240 determines that 200 milliseconds have elapsed since Core A exited the C6 state (e.g., since SMU 240 powered up Core A). In this time, assume that cache 230 of Core A has been partially filled (e.g., greater than a threshold amount) with information based on applying the throttle-up prefetching policy described herein in connection with FIGS. 4A-4C. As shown by reference number 610, assume that SMU 240 consults a state table to select a throttle-down prefetching policy based on a current state of Core A (e.g., based on determining that 200 milliseconds have elapsed since Core A exited the C6 state).

As shown by reference number 615, assume that the current state of Core A is “200 milliseconds elapsed since C6 Exit.” As further shown, based on this current state, SMU 240 selects a prefetching policy that causes Prefetcher A to be deactivated, and that causes Prefetcher B to be throttled down by only permitting five outstanding prefetch requests, rather than the ten outstanding prefetch requests permitted under the throttle-up prefetching policy. Finally, the selected prefetching policy continues to prioritize prefetch requests (e.g., from Prefetcher B) over cache miss requests. This prefetching policy is provided as an example. In some implementations, cache miss requests may be prioritized over prefetch requests.

As shown in FIG. 6B, and by reference number 620, based on the selected prefetching policy, SMU 240 deactivates Prefetcher A. As shown by reference number 625, SMU 240 provides information identifying the new prefetching policy to Prefetcher B. As shown by reference number 630, SMU 240 instructs Prefetcher B to reduce a quantity of outstanding prefetch requests from ten to five (e.g., indicating that only five outstanding prefetch request are permitted), and that prefetch requests are to be prioritized over cache miss requests.

As shown in FIG. 6C, and by reference number 635, Prefetcher B reduces a quantity of prefetch requests from ten to five. As shown by reference number 640, Prefetcher B requests, from main memory 260, information from five memory addresses shown as 111 through 115, in accordance with the selected prefetching policy. As shown by reference number 645, main memory 260 provides the information stored in memory addresses 111 through 115 to cache 230. In this way, Prefetcher B may continue to fill cache 230 with information, but at a lesser rate than a rate immediately following power up of Core A.

As indicated above, FIGS. 6A-6C are provided merely as an example. Other examples are possible and may differ from what was described with regard to FIGS. 6A-6C.

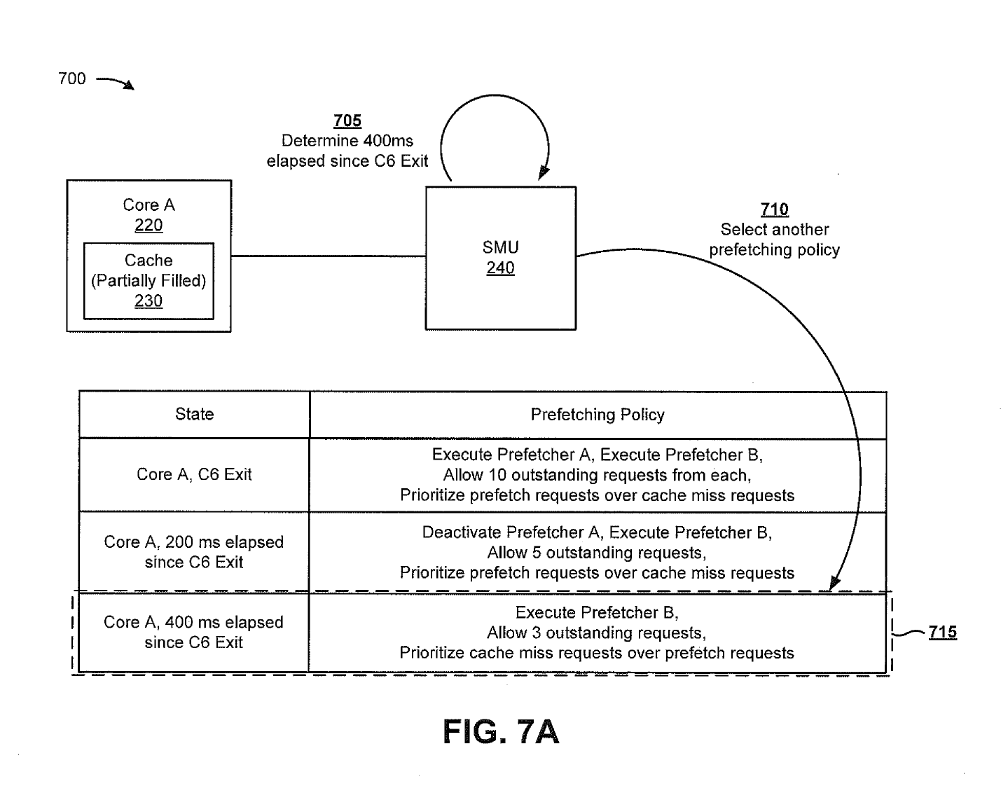

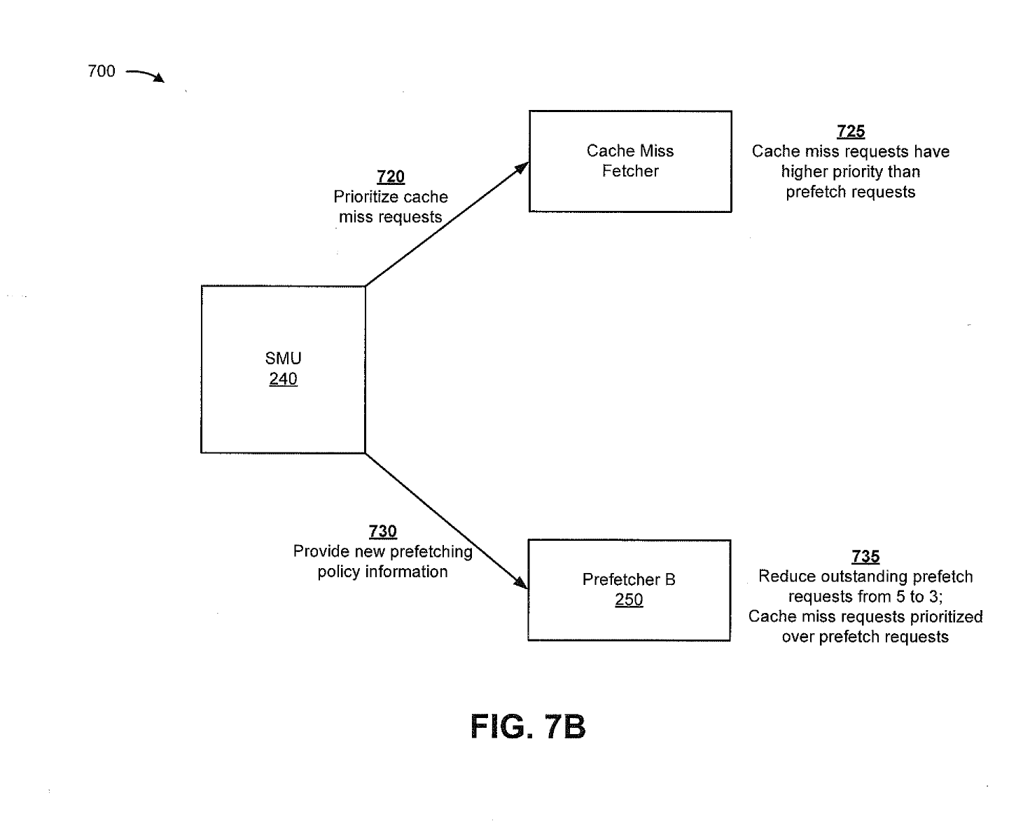

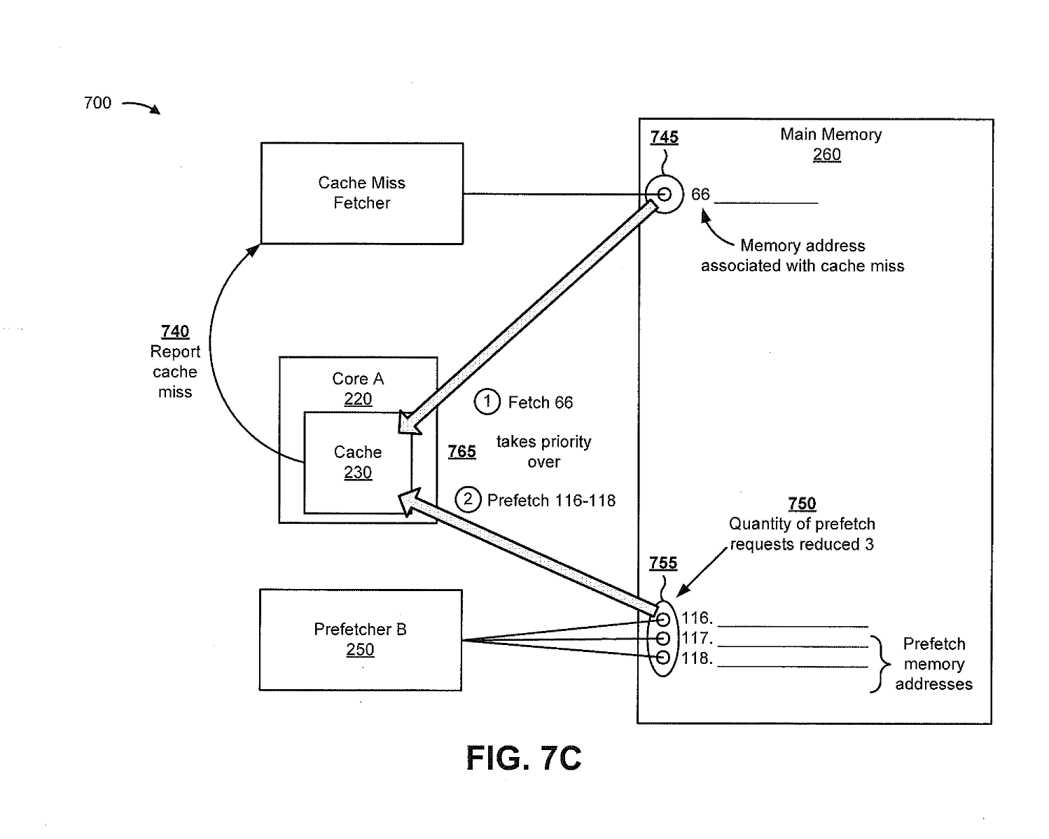

FIGS. 7A-7C are diagrams of another example embodiment 700 relating to example process 500 shown in FIG. 5. FIGS. 7A-7C show an example of prefetching data for a processor cache using a different prefetching policy. For the purpose of FIGS. 7A-7C, assume that the operations described in connection with example embodiment 400 of FIGS. 4A-4C and example embodiment 600 of FIGS. 6A-6C have been performed.

As shown in FIG. 7A, and by reference number 705, assume that SMU 240 determines that 400 milliseconds have elapsed since Core A exited the C6 state (e.g., since SMU 240 powered up Core A). As shown by reference number 710, assume that SMU 240 consults a state table to select another prefetching policy based on a current state of Core A (e.g., based on determining that 400 milliseconds have elapsed since Core A exited the C6 state).

As shown by reference number 715, assume that the current state of Core A is “400 milliseconds elapsed since C6 Exit.” As further shown, based on this current state, SMU 240 selects a prefetching policy that causes Prefetcher B to be further throttled down by only permitting three outstanding prefetch requests, rather than the five outstanding prefetch requests permitted under the previous prefetching policy. Finally, the selected prefetching policy prioritizes cache miss requests over prefetch requests, rather than prioritizing prefetch requests over cache miss requests.

As shown in FIG. 7B, and by reference number 720, based on the selected prefetching policy, SMU 240 notifies a cache miss fetcher (e.g., associated with Core A and cache 230) that cache miss requests are to be prioritized over prefetch requests. As shown by reference number 725, the cache miss fetcher receives instructions indicating the cache miss requests have a higher priority than prefetch requests. As shown by reference number 730, SMU 240 provides information identifying the new prefetching policy to Prefetcher B. As shown by reference number 735, SMU 240 instructs Prefetcher B to reduce a quantity of outstanding prefetch requests from five to three, and instructs Prefetcher B to prioritize cache miss requests over prefetch requests.

As shown in FIG. 7C, and by reference number 740, assume that Core A provides information, to the cache miss fetcher, indicating that cache 230 has experienced a cache miss (e.g., Core A has requested information that is not available in cache 230). As shown by reference number 745, the cache miss fetcher requests, from main memory 260, information stored in a memory address, shown as memory address 66, associated with the cache miss.

As shown by reference number 750, Prefetcher B reduces a quantity of prefetch requests from five to three. As shown by reference number 755, Prefetcher B requests, from main memory 260, information from three memory addresses shown as 116 through 118, in accordance with the selected prefetching policy. As shown by reference number 765, main memory 260 provides the information stored in memory addresses 66 and 116 through 118 to cache 230. Assume that SMU 240 coordinates this provision such that the information stored in memory address 66 is provided to cache 230 before the information stored in memory address 116 through 118. In this way, Core A may perform more efficiently after cache 230 has been filled with some information.

As indicated above, FIGS. 7A-7C are provided merely as an example. Other examples are possible and may differ from what was described with regard to FIGS. 7A-7C.

The foregoing disclosure provides illustration and description, but is not intended to be exhaustive or to limit the embodiments to the precise form disclosed. Modifications and variations are possible in light of the above disclosure or may be acquired from practice of the embodiments.

As used herein, a component is intended to be broadly construed as hardware, firmware, or a combination of hardware and software.

Some embodiments are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

It will be apparent that systems and/or methods, as described herein, may be implemented in many different forms of software, firmware, and hardware in the embodiments illustrated in the figures. The actual software code or specialized control hardware used to implement these systems and/or methods is not limiting of the embodiments. Thus, the operation and behavior of the systems and/or methods were described without reference to the specific software code—it being understood that software and hardware can be designed to implement the systems and/or methods based on the description herein.

Even though particular combinations of features are recited in the claims and/or disclosed in the specification, these combinations are not intended to limit the disclosure of possible embodiments. In fact, many of these features may be combined in ways not specifically recited in the claims and/or disclosed in the specification. Although each dependent claim listed below may directly depend on only one claim, the disclosure of possible embodiments includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Similarly, a “set” is intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A method, comprising:
determining, by a device, that a processor has transitioned from a first power consumption state to a second power consumption state;
determining, by the device, a first prefetching policy based on determining that the processor has transitioned from the first power consumption state to the second power consumption state,
the first prefetching policy for prefetching information to be provided to a cache;
determining, by the device, that a prefetch modification event has occurred; and
determining, by the device, a second prefetching policy based on determining that the prefetch modification event has occurred,
the second prefetching policy being different from the first prefetching policy.

2. The method of claim 1, where the first power consumption state is a lower power consumption state relative to the second power consumption state, and where the second power consumption state is a higher power consumption state relative to the first power consumption state.

3. The method of claim 1, further comprising:
determining that a threshold amount of time has elapsed since determining that the processor has transitioned from the first power consumption state to the second power consumption state;
wherein determining that the prefetch modification event has occurred comprises determining that the threshold amount of time has elapsed.

4. The method of claim 1, further comprising:
determining a performance parameter associated with the processor or the cache;
determining that the performance parameter satisfies a threshold;
wherein determining that the prefetch modification event has occurred comprises determining that the performance parameter satisfies the threshold.

5. The method of claim 1, further comprising:
prefetching first information, to be provided to the cache, at a first rate based on the first prefetching policy; and
prefetching second information, to be provided to the cache, at a second rate based on the second prefetching policy,
the second rate being different than the first rate.

6. The method of claim 1, further comprising:
prefetching, based on the first prefetching policy, first information that fills the cache more quickly than second information prefetched based on the second prefetching policy; and
prefetching, based on the second prefetching policy, second information that fills the cache more slowly than the first information prefetched based on the first prefetching policy.

7. The method of claim 1, further comprising:
prefetching first information, to be provided to the cache, using a first set of prefetchers based on the first prefetching policy; and
prefetching second information, to be provided to the cache, using a second set of prefetchers based on the second prefetching policy,
the second set of prefetchers being different from the first set of prefetchers.

8. A device, comprising:
one or more components to:
detect that a processor has transitioned from a low power state to a high power state;
determine a first prefetching policy based on detecting that the processor has transitioned from the low power state to the high power state;
prefetch information, for storage by a cache associated with the processor, based on the first prefetching policy;
determine a second prefetching policy after prefetching information based on the first prefetching policy,
the second prefetching policy being different from the first prefetching policy; and
prefetch information, for storage by the cache, based on the second prefetching policy.

9. The device of claim 8, where the one or more components, when prefetching information based on the first prefetching policy, are further to:
permit a first quantity of outstanding prefetch requests; and
where the one or more components, when prefetching information based on the second prefetching policy, are further to:
permit a second quantity of outstanding prefetch requests,
the second quantity being different from the first quantity.

10. The device of claim 8, where the one or more components, when prefetching information based on the first prefetching policy, are further to:
prioritize prefetch requests, associated with the first prefetching policy, over cache miss requests; and
where the one or more components, when prefetching information based on the second prefetching policy, are further to:
prioritize cache miss requests over prefetch requests associated with the second prefetching policy.

11. The device of claim 8, where the one or more components, when prefetching information based on the first prefetching policy, are further to:
prefetch information using a first prefetcher that cannot be trained to modify prefetching decisions; and
where the one or more components, when prefetching information based on the second prefetching policy, are further to:
prefetch information using a second prefetcher that can be trained to modify prefetching decisions.

12. The device of claim 8, where the one or more components, when prefetching information based on the first prefetching policy, are further to:
prefetch information using a first prefetching algorithm that fills the cache quicker than a second prefetching algorithm; and
where the one or more components, when prefetching information based on the second prefetching policy, are further to:
prefetch information using the second prefetching algorithm.

13. The device of claim 8, where the one or more components are further to:
determine that a threshold amount of time has elapsed since detecting that the processor has transitioned from the low power state to the high power state; and
where the one or more components, when determining the second prefetching policy, are further to:
determine the second prefetching policy based on determining that the threshold amount of time has elapsed.

14. The device of claim 8, where the one or more components are further to:
determine a performance parameter associated with the processor or the cache;
determine that the performance parameter satisfies a threshold; and
where the one or more components, when determining the second prefetching policy, are further to:
determine the second prefetching policy based on determining that the performance parameter satisfies the threshold.

15. A system, comprising:
one or more devices to:
determine that a processor has powered up;
determine a first prefetching policy based on determining that the processor has powered up;
fetch information, from a main memory and for storage by a cache associated with the processor, using the first prefetching policy;
determine, after fetching information using the first prefetching policy, to apply a second prefetching policy that is different than the first prefetching policy; and
fetch information, from the main memory and for storage by the cache, using the second prefetching policy.

16. The system of claim 15, where the processor includes a processor core.

17. The system of claim 15, where the one or more devices, when determining that the processor has powered up, are further to:
determine that the processor has transitioned out of a state that causes the cache to reduce an amount of information stored in the cache.

18. The system of claim 15, where the one or more devices, when determining to apply the second prefetching policy, are further to:
determine to apply the second prefetching policy based on at least one of:
an amount of time that has elapsed since the processor has powered up, or
a performance parameter associated with the processor or the cache.

19. The system of claim 15, where the one or more devices, when fetching information using the first prefetching policy, are further to:
fetch information using a plurality of prefetchers or one or more of a plurality of prefetching algorithms; and
where the one or more devices, when fetching information using the second prefetching policy, are further to:
fetch information using a subset of the plurality of prefetchers or a subset of the plurality of prefetching algorithms.

20. The system of claim 15, where the one or more devices, when fetching information using the first prefetching policy, are further to:
apply a first priority level to requests for information fetched using the first prefetching policy; and
where the one or more devices, when fetching information using the second prefetching policy, are further to:
apply a second priority level to requests for information fetched using the second prefetching policy,
the second priority level being lower than the first priority level.
